(19) United States
(12) Patent Application Publication
(10) Pub. No.: US 2006/0241791 A1
(43) Pub. Date: Oct. 26, 2006

(54) Method for simulating a process line

(75) Inventors: Sascha Pokorny, Solingen (DE); Ralf Reifferscheidt, Duisburg (DE); Joachim Meier, Leichlingen (DE); Joachim Hennig, Dresden (DE)

Correspondence Address: WOODCOCK WASHBURN LLP, ONE LIBERTY PLACE, 46TH FLOOR, PHILADELPHIA, PA, 19103, US

(73) Assignee: Henkel Kommanditgesellschaft Auf Aktien, Duesseldorf (DE)

(21) Appl. No.: 11/404,605

(22) Filed: Apr. 14, 2006

Related U.S. Application Data
(63) Continuation of application No. PCT/EP04/11178, filed on Oct. 6, 2004.

(30) Foreign Application Priority Data
Oct. 15, 2003 (DE) DE 10348019.6

(51) Int. Cl. G05B 11/32

(52) U.S. Cl. 700/67

(57) ABSTRACT

Methods for monitoring a process line and simulating changes in the process are described.

### CROSS-REFERENCE TO RELATED APPLICATIONS

This application is a continuation of PCT/EP2004/011178, filed Oct. 6, 2004, which claims priority to DE 10348019.6, filed Oct. 15, 2003, the disclosures of which are incorporated herein in their entireties.

### FIELD OF THE INVENTION

The present invention relates to a method for simulating a process line for monitoring the process or for simulating virtual changes in the process.

### BACKGROUND

A commercially available simulation program is described in http://www.ika.tz-dd.de; Mar. 20, 2003. This provides computer-assisted simulation of a machine arrangement, also termed process line in the following, having a plurality of processing machines coupled together in series. The simulation program PACSI uses, for example, the mean time between two failures (Mean Time Between Failure (MTBF)), the mean time between the occurrence of a fault and elimination thereof (Mean Time To Repair (MTTR)), and the respective processing speeds at which the respective processing machines operate it, as simulation input parameters (input variables).

In order to ensure a sufficiently precise simulation of the machine arrangement it is proposed to manually detect the behavior of the individual machine arrangement components. For example, it is known in this connection to manually detect all disturbances and the respective processing speed of the machines by a stopwatch. The manually detected values are input into a table and used as input variables within the scope of the simulation device described at http://www.ika.tz-dd.de; Mar. 20, 2003.

However, this manner of procedure is very complicated and costly. For example, the ‘measuring’, i.e. manual process data detection, demands from several man weeks to several man months in the case of a process line with approximately 20 packaging machines.

Moreover, these types of programs have no ability to factor in physical or spatial arrangements of machine components or characteristics particular to the building in which the process line is housed.

### SUMMARY

The present invention has the object of creating a computer-assisted simulation of a machine arrangement in which a flexible planning is made possible with consideration of changes in the physical arrangement of the individual machines within the machine arrangement.

The object is fulfilled by the method for computer-assisted simulation of a machine arrangement and by the machine simulation arrangement with the features according to the independent patent claims.

### BRIEF DESCRIPTION OF THE DRAWINGS

FIGS. 1a to 1c show a machine arrangement according to an example of embodiment of the invention;

FIG. 2 shows a symbolic block diagram in which the system for detection and simulation of a machine arrangement in accordance with an example of embodiment of the invention is illustrated; and

FIG. 3 shows a block diagram in which the data flow of the individual simulation parameters from the packaging line up to the simulation and optimization in the simulation program is illustrated.

### DETAILED DESCRIPTION

The present invention has the object of creating a computer-assisted simulation of a machine arrangement in which a flexible planning is made possible with consideration of changes in the physical arrangement of the individual machines within the machine arrangement.

Means for detecting physical arrangements are known. For example, a three-dimensional laser scanner (3D laser scanner) is described in IQVOLUTION, product catalogue (with respect to the IQVOLUTION laser scanner and the associated IQVOLUTION software), which is commercially available and by which the physical geometry of a building, for example of a factory, and the objects located in the building can be measured and thus detected with a linearity error of 3 millimeters referred to a scan of 50 meters. The respective building interior can be scanned by means of the laser scanner and a digital point cloud is formed, i.e. a quantity of data points in a three-dimensional data point area, wherein at least one brightness value (luminance value) and preferably additionally or alternatively a color value (chrominance value) is or are associated with each data point. Each data point of the scanning result in the three-dimensional data point area corresponds with a real physical point in the scanned building, more precisely in the building interior. The point cloud is used in order to determine the geometry of the scanned building or scanned area and the three-dimensional objects disposed therein and to model possible virtual three-dimensional objects corresponding with the physical objects in the external dimensions thereof and shapes.

According to the available product of IQVOLUTION, product catalogue (with respect to the IQVOLUTION laser scanner and the associated IQVOLUTION software) the result of the laser scan is a data set in a CAD data format (Computer-Aided Design data format), by which with use of a commercially available conventional CAD system it is made possible to directly process and optionally vary ‘static’ data, also termed hereunder static building data and/or static system data of a building and/or of machine arrangement components of the machine arrangement.

In the case of a method for computer-assisted simulation of a machine arrangement, which comprises a plurality of machine arrangement components, static building data and/or static system data of a building and/or of machine arrangement components of the machine arrangement are detected at the beginning of the method, preferably measured by means of a laser scanner. In addition, process data describing the operation of at least one machine arrangement component of the machine arrangement are measured at the beginning of the method and/or during the method by means of mobile sensors mounted at the machine arrangement components, each mobile sensor being uniquely associated with at least one machine arrangement component. The machine arrangement is simulated in its processing behavior with use of the static building data, the static system data, the process data and a simulation model of the machine arrangement components as input variables.

The machine arrangement is simulated with use of these input variables, i.e. clear static input variables input once and dynamic input variables which are continuously and repeatedly detected by means of mobile sensors in operation of the machine arrangement and which describe the operation of at least one machine arrangement component of the machine arrangement.

The static input variables describe, for example, the physical structure of the machine arrangement and the process data describe, for example, the operating variables, i.e. sensor values detected in operation of the machine arrangement or of the individual machine arrangement components.

A machine simulation arrangement for computer-assisted simulation of a machine arrangement, which has a plurality of machine arrangement components, comprises a plurality of mobile sensors mountable at the machine arrangement components for detection of process data describing the operation of at least one machine arrangement component of the machine arrangement. Moreover, equipment for detection of static building data and/or static system data of a building and/or of machine arrangement components of the machine arrangement is provided. A simulation device similarly provided in the machine simulation arrangement comprises a first memory for storage of the detected static building data and/or the detected static system data, a second memory for storage of the detected process data, a third memory for storage of simulation models of the machine arrangement components and a fourth memory for storage of a simulation program. In addition, data processing equipment is provided, the equipment being so arranged that with use of the static building data and/or static system data, the process data, the simulation models and the simulation program the machine arrangement is simulated in its processing behavior.

By plurality of memories there is to be understood in this description also a plurality of memory regions of one physical memory.

Thus, static building data and/or static system data of a building and/or of machine arrangement components of the machine arrangement are stored in a first memory or in a first memory region.

Process data describing the operation of at least one machine arrangement component of the machine arrangement, preferably process data detected during operation of the machine arrangement by means of mobile sensors mounted at the machine arrangement components, are stored in the second memory or in a second memory region.

A multiplicity or a plurality of simulation models of the respective machine arrangement components provided in the machine arrangement is stored in the third memory or in a third memory region.

A simulation program, which during execution thereof performs the method steps in accordance with the above-described method, is stored in a fourth memory or in a fourth memory region.

The invention can be clearly seen in that not only static data with respect to the physical arrangement of machine arrangement components of a machine arrangement are represented in a CAD system or not only—as in accordance with the state of the art—the process data are exclusively used within the scope of the simulation of a machine arrangement, but that in accordance with the invention a simulation, which is improved relative to the state of the art because it is more accurate and flexible, of the machine arrangement is achieved by way of dovetailing within the scope of the simulation the static data about the machine arrangement, i.e. particularly the physical data about the individual machine arrangement components and the disposition thereof within the machine arrangement, together with the process data which was detected by means of the mobile sensor system and describes the operation of the individual machine arrangement components within the machine arrangement.

A significant advantage of the invention is to be seen in the automatic detection of the process data and in the provision of the precisely, preferably automatically, detected static data, which are used conjunctively in the simulation.

In this manner it is possible in accordance with the invention for the first time to locally displace, interactively by a user in desired manner, very simply and flexibly in a simulation tool the individual logistical objects describing physical objects, i.e. the machine arrangement components of a machine arrangement, in their characteristics and to take into consideration this displacement directly in a simulation of the processing behavior of the machine arrangement now changed in its local disposition.

Preferred developments of the invention are evident from the dependent claims.

The embodiments of the invention described in the following relate to the method for computer-assisted simulation of a machine arrangement and the machine simulation arrangement.

The invention can be realized not only as hardware, i.e. by means of a specially equipped electrical circuit, but also as software or in desired parts as both hardware and software.

According to one embodiment of the invention the measured process data are subjected to an intermediate processing, particularly a data reduction. Stated differently, processing of the detected ‘raw data’ is carried out preferably specifically to the machine arrangement components. The processing can be filtering, collating, formation of characteristic magnitudes describing the detected data, statistical analysis of the detected data, etc. The result of the intermediate processing i.e. the intermediately processed process data, is used within the scope of the simulation.

Preferably, machines of the machine arrangement, preferably equipped as processing machines, and/or conveyor lines of the machine arrangement, which interconnect the individual machines, are taken into consideration within the scope of the simulation.

According to another embodiment of the invention the process data of all machine arrangement components provided in the machine arrangement and disposed in operation are taken into consideration within the scope of the simulation of the machine arrangement.

The static building data and/or static system data can be detected once at the beginning of the method, the detection preferably being at least partly by means of a laser scanner, particularly preferably at least partly by means of a 3-dimensional laser scanner such as described in, for example, IQVOLUTION, product catalogue (with respect to the IQVOLUTION laser scanner and the associated IQVOLUTION software).

Data with respect to the structure of the building and/or geometry data with respect to the building can be detected and used as static building data according to an embodiment of the invention.

At least a part of the following data can be used as static system data:
data with respect to the structure of the machine arrangement and/or the machine arrangement components of the machine arrangement;
geometry data with respect to the machine arrangement and/or the machine arrangement components of the machine arrangement;
production plan data;
data with respect to the products, intermediate products and/or packaging means to be processed by the machine arrangement;
housekeeping data with respect to the operation of the machine arrangement and/or the machine arrangement components.

The static data are preferably detected once before the start of the operation of the packaging line, generally the machine arrangement, and are usually present at least partly in a CAD data format and/or in a general ASCII data format.

The process data, thereagainst, are dynamic data continuously and repeatedly determined by means of mobile sensors mounted at the machine arrangement components. According to an embodiment of the invention at least a part of the following data are determined by means of the sensors as process data and used within the scope of the simulation;
failure data with respect to a failure of a machine arrangement component:
speed data of a machine arrangement component;
data by which the processing quantities of articles in a machine arrangement component per unit of time are indicated;
a time statement by which the point in time at which the data was detected is indicated.

It has proved that the above-described process data, in particular, is very suitable for ensuring a precise and reliable simulation of a process line.

According to another embodiment of the invention virtual/reality planning data (Virtual Reality planning data) are taken into consideration within the scope of the simulation of the machine arrangement. The virtual/reality planning data are preferably formed by means of computer-assisted virtually/reality planning equipment and input as input variables of the simulation, wherein the virtual/reality planning equipment can be team-oriented and team-based interactive planning equipment.

A team-based interactive production planning system, also termed 3D planning table, is known in http://www.ipa.fhg.de; Jul. 23, 2003. As input variables use is made according to http://www.ipa.fhg.de; Jul. 23, 2003 of data in a VRML data format (Virtual Reality Modeling Language data format) in order to indicate three-dimensional models of machines, logistical components or other elements in platform-independent manner in two-dimensional or three-dimensional representation to a user. A two-dimensional image of a production system is, according to the system described in http://www.ipa.fhg.de; Jul. 23, 2003, projected onto a table and a user of the system can select a virtual image by means of a reflective brick (reflective cube) in that the user places the reflective cube on the table at a corresponding position over the virtual object. The position of the cube is detected by means of a camera and determined by means of a suitable computer program for pattern recognition. If the virtual object is selected by means of the cube, then this can equally be displaced by displacing the cube on the table surface. The displacement of the cube is similarly detected by the camera and is recognized and taken into consideration in the computer program, so that the virtual object is displaced in corresponding manner. In this way it is possible to very simply and quickly carry out virtual displacement of elements of a process line in their physical arrangement and to calculate the result of the displacement and represent it to a user with respect to the external appearance within a virtual/reality environment.

The system described in http://www.ipa.fhg.de; Jul. 23, 2003, i.e. the three-dimensional planning table of Fraunhofer Instituts für Produktionstechnik und Automatisierung, is particularly preferred.

In addition, a software optimization program which is termed ISSOP and also commercially available is described in http://www.dualis.net; Mar. 20, 2003. This optimization program provides different, for example empirically-based, gradient-based and model-based, optimization methods able to be used within the scope of a process optimization.

In this manner it is advantageously possible, in very simple and flexible manner, within the scope of the simulation to change—without additional outlay and also in an interactive procedure with the user of a planning table—static data such as, for example, the local arrangement of the machines within a process line and to directly take these changes into consideration within the scope of the simulation.

For this purpose there is preferably provided an integration platform converting the data formats of the obtained—preferably by a three-dimensional laser scanner—static building data or static system data, as well as the data format of the data produced by the virtual/reality planning table, into a data format able to be used by the simulation program.

For the simulation program it is preferable for this to be able to be integrated in a browser program, preferably in a World-Wide Web-browser program (for example INTERNET EXPLORER, NETSCAPE NAVIGATOR or NSCA MOSAIC), or to be able to be represented by means of this to a user, preferably by means of a JAVA-PLUGIN or an APPLET, so that the simulation and the planning can, with use of the Internet, be embedded in any distributed system with any computer architecture.

At least a part of the machines can be arranged as processing machines, particularly preferably as packaging machines.

According to an embodiment of the invention at least a part of the machines is arranged as one of the following machines: bottle erecting machine; material filling machine; cap sorting machine; cap aligning machine; bottle sealing machine; machine for lifting out of bottle shoes; bottle labeling machine; coding machine; sticker machine; foil shrink-wrapping machine; multi-pack erecting machine; carton packaging machine; carton closing machine; carton label printing machine; check weigher; palletting machine.

According to one embodiment of the invention, the above-described three components of a simulation program, for example of the simulation program PACSI—are expanded in accordance with the invention for the processing of data according to the described method step—a model, formed by means of a three-dimensional laser scanner, of a building and/or the machine arrangement components of a machine arrangement as well as a virtual/reality planning system enables rapid and economic design or variation of a packaging line.

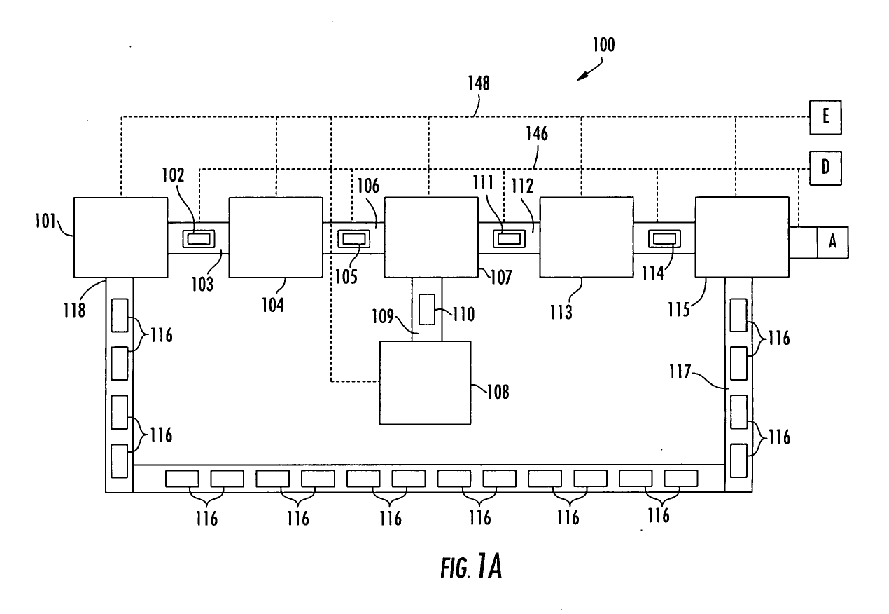

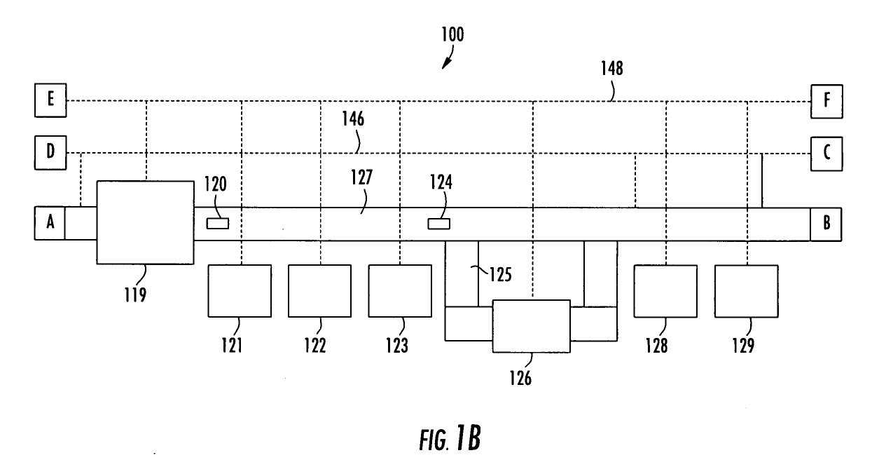

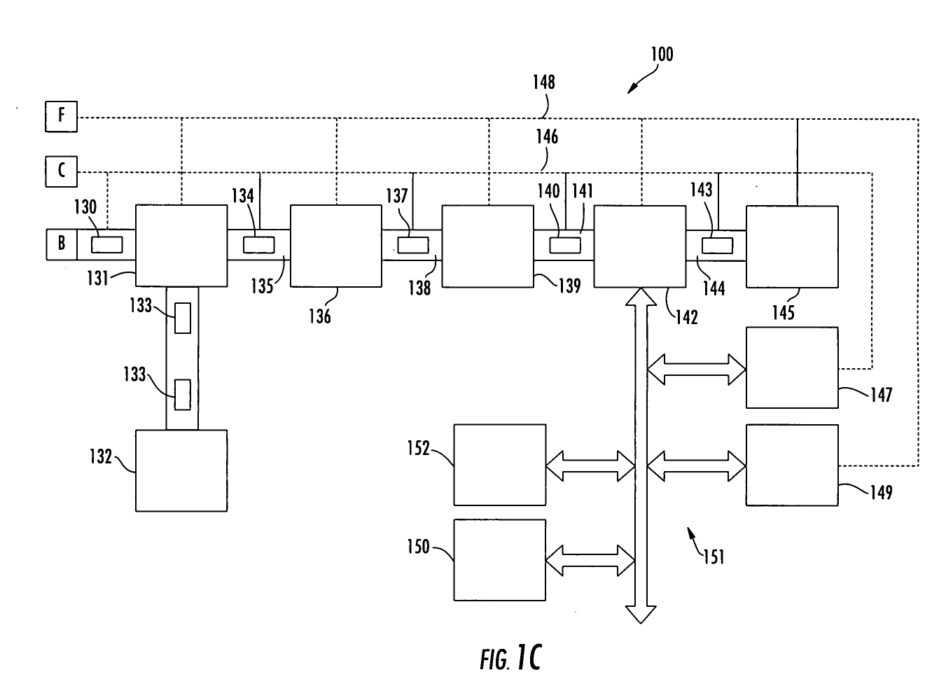

FIG. 1a to FIG. 1c show a machine arrangement 100 according to an example of embodiment of the invention. Reference numerals are listed in Table 1.

TABLE 1
Reference Numeral List

| | |
|---|---|
| 100 | machine arrangement |
| 101 | bottle erecting machine |
| 102 | bottle |
| 103 | conveyor line |
| 104 | filling machine |
| 105 | filled bottle |
| 106 | conveyor line |
| 107 | cap aligning machine |
| 108 | cap sorting machine |
| 109 | conveyor line |
| 110 | cap |
| 111 | bottle provided with cap |
| 112 | conveyor line |
| 113 | bottle sealing machine |
| 114 | sealed bottle |
| 115 | bottle shoe lifting-out machine |
| 116 | bottle shoe |
| 117 | conveyor line |
| 118 | secondary flow inlet of bottle erecting machine |
| 119 | labeling machine |
| 120 | labeled bottle |
| 121 | coding machine |
| 122 | first sticker machine |
| 123 | second sticker machine |
| 124 | identified bottle |
| 125 | secondary conveyor line |
| 126 | foil shrink-wrapping machine |
| 127 | main conveyor line |
| 128 | third sticker machine |
| 129 | fourth sticker machine |
| 130 | finished identified bottle |
| 131 | carton packaging machine |
| 132 | multi-pack erecting machine |
| 133 | carton |
| 134 | carton with bottles inserted therein |
| 135 | conveyor line |
| 136 | carton closing machine |
| 137 | closed carton |
| 138 | conveyor line |
| 139 | carton label printing machine |
| 140 | printed carton |
| 141 | conveyor line |
| 142 | check weigher |
| 143 | weighed carton |
| 144 | conveyor line |
| 145 | palletting machine |
| 146 | first field bus |
| 147 | lines control unit |
| 148 | second field bus |
| 149 | process stabilization control computer |
| 150 | measured data database management computer |
| 151 | Ethernet |
| 152 | simulation computer |
| 200 | system |
| 201 | three-dimensional laser scanner |
| 202 | laser scanner computer |
| 203 | machine database |
| 204 | integration platform computer |
| 205 | three-dimensional planning table |
| 300 | block diagram |
| 301 | structure data |
| 302 | geometry data |
| 303 | production plan data |
| 304 | product data and packaging material data |
| 305 | housekeeping data |
| 306 | failure data |
| 307 | speed data |
| 308 | quantity data |
| 309 | time data |
| 310 | failure parameter data |
| 311 | speed data |
| 312 | quantity data |
| 313 | time data |

The machine arrangement 100 comprises a bottle erecting machine 101 arranged in such a manner that empty bottles 102 fed to the bottle erecting machine 101 are inserted into bottle shoes 116, which are described in more detail in the following, in order to thus ensure increased stability of the bottles 102.

After the bottles have been inserted into the bottle shoes 116 the bottles 102 are fed by means of a conveyor belt (conveyor line) 103 to a filling machine 104. In the filling machine 104 a product, which is to be introduced into each container, is brought into the container; according to this example of embodiment, the desired liquid, namely hair shampoo, is filled into the bottle 102 fed to the filling machine 104.

The bottle 105 provided with the liquid is transported by means of a further conveyor line 106 from the filling machine 104 to a cap aligning machine 107 and fed thereto. Closure caps 110 are fed by way of a secondary inlet into a secondary flow of the cap aligning machine 107 from a cap sorting machine 108 via a further conveyor line 109 and are fitted by the cap aligning device 107 onto the filled bottles 105.

The bottles 111 with the fitted covers are fed by way of a further conveyor line 112 to a bottle sealing machine 113, by which the bottles 111 with the caps 110 are completely sealed so that the hair shampoo can no longer flow out of the bottle 111.

The bottles 114 sealed by the caps 110 are fed to a bottle shoe lifting-out machine 115 in which the filled bottles 114 closed by the caps are lifted out of the bottle shoes 116. The now empty bottle shoes 116 are fed again by way of a further conveyor line 117 to a secondary flow inlet 118 of the bottle erecting machine 101.

The bottles 114 are subsequently fed by means of an additional conveyor line 118 to a labeling machine 119 by which predeterminable labels are applied to the bottles 114.

Additional predeterminable codes are applied to the labeled bottles 120 by means of a coding machine 121, for example by means of ink-jet printing. In addition, additional information is stuck to the bottles by means of two sticker machines 122, 123.

Distinction is to be made between two cases for the further course of production, on the one hand single-bottle packaging and on the other hand multi-bottle packaging, i.e. the combination of a predeterminable number of bottles which are weld-sealed in common in one foil. According to this example of embodiment it is possible for any predeterminable number of bottles, preferably five bottles, to be weld-sealed in common in one foil. If this is desired, then the bottles 124—labeled and identified by additional information—are fed by way of an auxiliary conveyor line 125 to a five-unit foil shrink-wrapping machine 126, in which in each instance five bottles are wrapped in common in one foil and weld-sealed and the foil is subjected to shrinkage in a shrinking oven. If the bottles 124 are to be packaged individually, then the bottles 124—labeled and identified with additional information—are led on by way of the main conveyor 127 past the foil shrink-wrapping machine 126.

Subsequently, two additional sticker machines 128, 129 by means of which additional items of information can be applied to the foils in which the bottles are packed are provided in the further production path.

The bottles 130 fully marked in this matter are fed to a carton packing machine 131 by means of which the bottles 130 are packed in cartons 133 fed to the carton packing machine 131 by way of a secondary inlet. The cartons 130 are erected in a multi-pack erecting machine 132, folded in predetermined manner and fed to the secondary inlet of the carton packing machine 131.

The cartons 134 filled with the bottles are fed by way of a further conveyor line 135 to a carton closing machine 136 in which the cartons 134 are closed.

The closed cartons 137 are transported, again by means of a conveyor line 138, from the carton closing machine 136 to a carton label printing machine 139 in which predeterminable labels are printed on the cartons 137. The cartons 140 provided with labels are fed, again by means of a conveyor line 141, to a check weigher 142 by which the correct weight of each filled and closed carton 137 is ascertained in order to check whether the cartons 137 are, in fact, completely filled. If the cartons are not completely filled then the incorrectly filled cartons are diverted out and the bottles filled in to new cartons. The correctly filled cartons 143 are fed by means of a further conveyor line 144 from the check weigher 142 to a palletting machine 145 by which the cartons 143 are stacked on pallets and subsequently delivered.

Sensors, for example light barriers, but alternatively or additionally, for example, pressure sensors or other sensors suitable for the respectively desired data detection are provided not only at the main flow inlets of the individual machines, but also at the secondary flow inlets of the machines, by way of which, for example, caps or cartons are fed to the respective machine—in general for processing material supplied for use with the stock actually being processed—as well as at the outlets of the machines and at any predeterminable positions of a conveyor line, thus generally a mobile sensor system, in order to ascertain the passage of elements, for example a bottle, through a light barrier and to count these products by, for example, counters which are also present and are coupled with the light barriers.

The conveyor lines are coupled by means of a first field bus 146, according to this example of embodiment a professional bus, with a lines control unit 147, according to this example of embodiment a memory-programmable control (MPC).

The machines are connected with a process stabilization control computer 149 by means of a second field bus, according to this example of embodiment similarly a professional bus 148.

Control variables by which the speed of the individual conveyor lines is set are fed by means of the lines control unit 147 to the individual flow lines. Control variables are fed by means of the process stabilization control computer 149 via the second field bus 148 to the individual machines and to the memory-programmable controls preferably provided in the machines, the control variables according to this example of embodiment being target speed values by which the individual target operating speed of the machine is set with use of the memory-programmable control of the respective machine.

In an alternative form of embodiment, for the case that some machines are not compatible with the field bus predeterminable signals are detected by means of separate remote input/output interfaces (not illustrated) or corresponding control variables are supplied to the respective machine in accordance with the respective proprietary data format supported by the respective machine.

The data recorded by the sensors are additionally fed by means of the first field bus 146 and/or the second field bus 148 to a measurement data detection computer 150, which is coupled with the lines control unit 147 as well as with the process stabilization control computer 149 by way of a local communications network 151—according to this example of embodiment, the Ethernet—and stored by this in a measurement data database. The measurement data database is managed by a database computer 150.

The sensors can optionally be coupled by way of a radio interface, for example arranged in accordance with the Bluetooth standard, with the measurement data detection computer 150.

A simulation program, according to this example of embodiment the technical computer simulation program PACSI, which is arranged and adapted in such a manner that it can perform the method steps described in the following, is stored in a simulation computer 152.

The simulation computer 152 is similarly coupled with the Ethernet 151 and by way of that with the above-mentioned computers 147, 149 and 150 so that data can be exchanged between the individual computers 147, 149, 150.

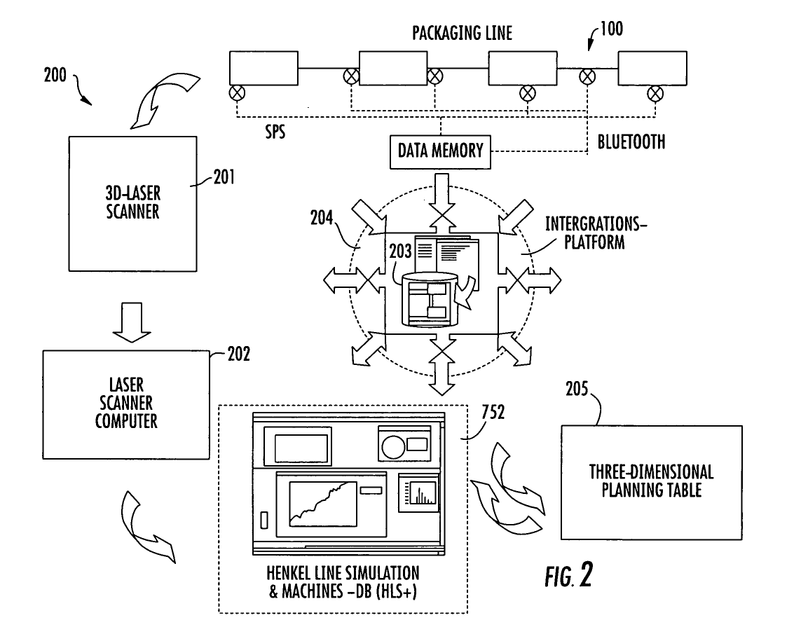

As is illustrated in the simulation and optimization system 200 in FIG. 2 the machine arrangement 100 and the building in which the machine arrangement 100 is located are three-dimensionally measured, i.e. scanned, by means of a three-dimensional laser scanner 201 arranged as described in a IQVOLUTION, product catalogue (with respect to the IQVOLUTION laser scanner and the associated IQVOLUTION software) and commercially available.

The building in which the machine arrangement 100 is arranged serves as a scanning reference system in which the scanning is undertaken by means of the three-dimensional laser scanner 201. Result of the measuring or the laser scan is a point cloud, i.e. a quantity of data points in a three-dimensional data space, wherein each data point corresponds with an actual point in the actual physical building. A brightness value (luminance value) and/or color value (chrominance value) is or are associated each data point of the point cloud. The totality of the data points thus represents a logical image of the pure spatial structure of the building as well as of the machine arrangement and, additionally, elements contained in the building, for example pipe ducts, projections, supports, etc.

A model of a digital three-dimensional factory is created from the point cloud manually or automatically in computer-assisted manner with use of methods, which are known per se, of digital data processing and object segmentation, wherein in addition individual three-dimensional object models of elements contained in the building, as well as pipe ducts, supports, projections, machines, conveyor lines and other structures located in the building, can be created. The result of this procedure, which is known per se, is a digital description of the building and the machine arrangement in object-oriented form, wherein the data is frequently present in the form of line models and in a CAD data format.

The data formed by means of the laser scanner 201 and, in particular, the line model or models, which is or are generated by a line model generating computer 202, of the building and the machine arrangement 100 are stored in an additional building and the machine database 203 in an integration platform computer 205. The integration platform computer 204 is coupled not only with the above-described computers 147, 149, 150 and 152, but also with the line model generating computer 202 producing the data evaluation and the formation of the line model and the data objects from the laser scan.

The integration platform computer 204 is arranged in such a manner that it converts the data formats of the static building data or static system data obtained by the three-dimensional laser scanner 201 as well as the data format of the data produced by the virtual/reality planning table 205 into a data format which can be used by the simulation program 152 within the scope of the simulation.

It is thus made possible to recognize and adapt structures and objects in the building, particularly the machine arrangement 100, by means of the IQVOLUTION software, which is equally available in connection with the system described in IQVOLUTION, product catalogue (with respect to the IQVOLUTION laser scanner and the associated IQVOLUTION software), and the three-dimensional laser scanner 201. The digital data are ascertained by means of direct measuring with use of the three-dimensional laser scanner 201, and an interface to a CAD system, which is known per se, is provided by means of the software of IQVOLUTION.

The created objects of the machine arrangement 100 can be parameterized and stored in their three-dimensional structure in the building and machine database 203. Additional data more closely explaining the characteristics with respect to the processing and the machine type are stored in the building and machine database 203.

Thus, according to this example of embodiment of the invention there is stored in the building and machine database 203 the following information—which is additional to the data obtained by the three-dimensional laser scanner with respect to the machines, generally the machine arrangement components—with respect to a machine object describing a machine:
a statement of the machine type or a statement of the machine type of a machine superordinate to the machine in question if the machine in question is a component of the superordinate machine;
a statement of an output of articles by the machine in items per minute, wherein not only the statement of the minimum output, a nominal output, but also a maximum output can be stored;
a statement of a volume range of elements able to be processed by means of the machine, as well as both a minimum volume and a maximum volume of an article to be processed by the machine in question;
a statement with respect to the mode of operation of the machine in question, for example whether the machine operates intermittently or continuously;
a statement, obtained from the statement of the laser scan or from manufacturer particulars, with respect to machine dimensions, particularly the length, breadth and height of the machine;
a statement with respect to the entry height of articles into the machine in question above the floor, indicated in millimeters;
an exit height of the articles from the machine in question above the floor, indicated in millimeters;
the weight of the machine in kilograms;
the energy requirement for operation of the machine, selectably indicated electrically in KW/h or pneumatically in Nm3/h.

In this manner a very accurate, specific description, which defines the machine both in its mode of operation and in its physical dimensions, is stored in the building and machine database 203. The description is, as explained in more detail in the following, used within the scope of the simulation by means of the simulation computer 152.

In summary, the position, geometry, structure and character of line elements, i.e. of machines in the machine arrangement 100, the machine arrangement itself, i.e. the process line, and the factory environment, i.e. the building environment, are detected by means of the three-dimensional laser scanner 201.

Parameters of the machine arrangement 100 are thus detected, i.e. according to this example of embodiment the filling and packaging machine arrangement, wherein the entire machine arrangement is detected by the following parameters:
start of the machine arrangement 100: bottle erecting machine 101;
end of the machine arrangement 100: palletting machine 145;
the product path, i.e. the machine arrangement topology, particularly the length of the paths, the linking of the paths (coupling points), number of tracks in the machine arrangement 100, capacity of an individual path, passages through walls and booths, etc., which are provided in the building, and empty stock return transport;
machine inlets and machine outlets;
transport locations and control locations;
control panel position;
position markers (for example, a DIN A4 sheet) for
light barriers (for example, for mobile data detection),
start and end of systems, etc.

In addition, the environment of the machine arrangement 100 is also detected by the following parameters by means of the three-dimensional laser scanner 201:
height restrictions and wall restrictions by
ceiling structures,
wall structures,
ceiling passages and wall passages;
floor structure and floor unevennesses,
doors, windows, staircases;
conveyors outside the immediate machine arrangement 100 (for example, arranged below the ceiling of the building);
steelwork and building technical structure, particularly
pipes and pipe routes for the transport of: gas, water, compressed air, heat, etc.,
channels, electric channels, ventilation channels, etc.,
connecting points for supplies with electricity, media and material;
switch cabinets outside the machine arrangement 100.

Data is detected by the above-described sensors during operation of the packaging machines of the machine arrangement 100.

The data thus represent the basis for determination of the items of process information and are also termed process data.

According to this example of embodiment sensors for detection of, in particular, the throughflow quantity of products through the respective machine, the speed of the machine, the state of the machine, etc., are provided in accordance with the respective need of the individual packaging machines of the machine arrangement 100, as described above.

The determined measurement data are stored in the measurement data database, as explained above, and are provided in correspondence with the integration platform computer 204.

In addition, a three-dimensional planning table 205 described in http://www.ipa.fhg.de; Jul. 23, 2003 is also provided in the simulation and optimization system 200. The three-dimensional planning table 205 represents an input surface and visualization surface, with the help of which an interactive co-operation in the team between all participating users of the three-dimensional planning cable 205 is made possible.

As described in http://www.ipa.fhg.de; Jul. 23, 2003 and commercially available per se, the three-dimensional planning table 205 comprises several components, particularly:
a beamer for three-dimensional projection,
a beamer for two-dimensional projection,
an image recognition unit and
a conventional personal computer of appropriate capacity.

In addition, a mirror and a table and a plurality of reflective bricks (reflective cubes) are provided, as well as a screen on which the three-dimensional projection by means of the beamer is represented.

The position of however many reflective cubes is recognized very rapidly by the image recognition unit. An object is selected in that a user places a reflective cube on the object, which is to be selected, in the projection surface, i.e. on the table surface of the three-dimensional planning table 205.

The system recognizes the reflective cube and identifies the logical object disposed thereunder, i.e. projected at this position. The logical object is marked and can also be logically displaced within the computer program by means of the user through displacement of the reflective cube on the table surface.

This takes place by a logical linking between the position of the reflective cube on the table surface and the position of the logical object within the simulation space.

If the reflective cube is thus displaced on the table surface, then the system adjusts the object in the computer program to the desired new position of the reflective cube.

The machine objects stored in the machine database 203 are selectable by means of the three-dimensional planning table 205 and the associated software and are displaceable at a virtual location of the digital, logical virtual building.

In this manner it is possible to logically displace, by means of the reflective cube, machine objects which have been determined in their position within a physical building by means of the three-dimensional laser scanner 201 and are described in detail in their characteristics and to store the logical geometry data, which is varied in this manner, in the machine database 203 or in an additional geometry data database in the integration platform computer 204 and thus to supply the data as input variable to a simulation executed by means of the simulation computer 152. According to the invention it is also possible to insert virtual machines into the virtual building within the scope of the simulation and thus to virtually construct a complete packaging machine arrangement.

The simulation computer 152 executes a simulation of the machine arrangement 100, thus data detected with use of the laser scan performed by means of the three-dimensional laser scanner 201, the process data detected by means of the mobile sensor system formed by the above-described sensors at the machine arrangement components, and the optionally changed geometry data varied by means of the three-dimensional planning table 205.

In this manner there is made possible not only a simulation, but also, with use of the similarly commercially available software tool ISSOP as described in http://www.dualis.net; Mar. 20, 2003 and available commercially, an optimization of the operation of the machine arrangement 100.

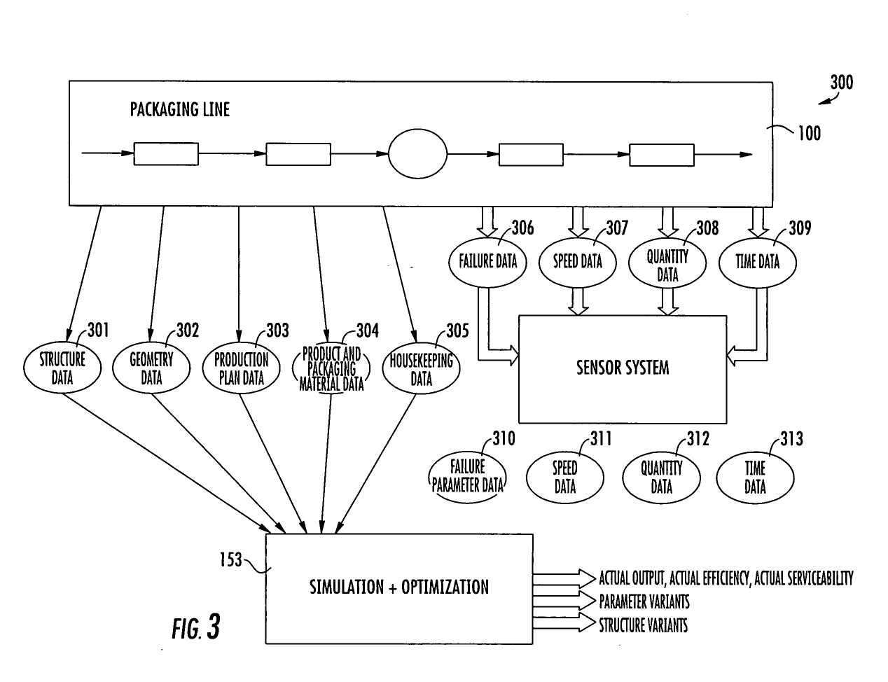

FIG. 3 shows in detail the data, which are respectively used within the scope of the simulation, in the form of a block diagram 300.

Referred to the machine arrangement 100, the following data, in particular, are detected by means of the three-dimensional laser scanner 201:
static data only precisely detected or input once, in particular:
structure data 301, particularly the construction of the machine arrangement 100, machine elements contained in the machine arrangement 100, and the linking thereof, i.e. statements with respect to how the individual machines are interconnected,
geometry 302, particularly statements with respect to the length, breadth and volumes of the respective machines of the machine arrangement;
production plan data 303, particularly data with respect to the quantities—which are to be processed in accordance with the plan by means of the machines of the machine arrangement 100—of articles, a statement with respect to the respective articles to be processed and possible planned conversions of the machines or the machines of the machine arrangement;
product data and packaging material data 304, particularly in the case of different kinds of products;
housekeeping data 305, particularly data with respect to different work shifts of the employees and operators of the machines, the breaks which the machines or the users of the machines have to keep to and a statement with respect to the number of machine operators.

Dynamic data are continuously detected by means of the mobile sensor system in operation of the machines of the machine arrangement 100, wherein, in particular, the following data are determined:
failure data 306, particularly statements with respect to machine inherent disturbances, with respect to build-ups of articles occurring at the machines and statements with respect to a deficiency of articles for each element, i.e. for each machine or for each conveyor line element of the machine arrangement;
speed data 307, particularly data with respect to the actual speed course for each machine or for each element of the machine arrangement;
quantity data 308, particularly statements with respect to the supplied quantities, delivered quantities or diverted quantities of the articles for each element monitored by means of the sensors;
time data 309, particularly actual time statements for failure data, actual time statements for speeds and actual time statements for the production by the individual elements of the machine arrangement 100.

Moreover, data derived from the data detected by means of the sensors are determined, particularly the following data:
failure parameter data 310, particularly statements with respect to the duration of failure, the failure interval, with respect to speed and time for each element of the machine arrangement 100;
speed data 311, particularly the statement with respect to the speed, considered in a predetermined time interval for each element of the machine arrangement;
quantity statements 312, particularly statements with respect to the quantities, considered in a speed interval and in a predetermined time interval for each element of the machine arrangement 100; and
time statements 313, particularly time stamps and time/function data.

These data are input into the simulation computer 152, optionally after conversion has been carried out of the data format or formats of the detected data formed by the integration platform computer 204, and processed by means of the simulation program, wherein the simulation program determines from the above-described input variables, in particular, an actual output of the respective machine, an efficiency of the respective machine and a serviceability of the respective machine.

What is claimed:

1. A method for simulating a process line, comprising:
generating a digital description of physical characteristics associated with a process line;
generating process information via a sensor associated with a component of the process line;
storing the digital description and process information in a memory component; and
integrating the stored data to model the function and structure of the process line.

2. The method of claim 1, wherein the method is used to monitor the process line.

3. The method of claim 1, wherein the method is used to simulate virtual changes in production of the process line upon changes in variables.

4. The method of claim 1, further comprising manipulating at least one of the digital description and process information.

5. The method of claim 1, further comprising displaying the model on an output component.

6. The method of claim 1, wherein the digital description of the process line area is in object-oriented form.

7. The method of claim 1, wherein the digital description is a scaled model.

8. The method of claim 1, wherein the digital description is generated via a laser scanner.

9. The method of claim 1, wherein the digital description is generated via a 3D laser scanner.

10. The method of claim 1, wherein the at least one sensor is dedicated to a component.

11. The method of claim 1, wherein the digital description includes information regarding at least one of a building structure and a geometry associated with the building housing the process line.

12. The method of claim 1, wherein the digital description includes information regarding at least one component associated with the process line.

13. The method of claim 12, wherein the digital description includes at least one of data associated with component structure, component geometry, production plan, products, intermediate products, packaging, speed, or housekeeping.

14. The method of claim 1, wherein the process data comprises at least one of data associated with failure, speed, processing quantity, or time.

15. A method for simulating a process line, comprising:
generating a digital description of physical characteristics associated with a process line;
generating process information via a sensor associated with a component of the process line, wherein the at least one sensor is dedicated to a component;
storing the digital description and process information in a memory component;
manipulating at least one of the digital description and process information; and
integrating the stored data to model the function and structure of the process line.

16. The method of claim 15, wherein the digital description is generated via a laser scanner.

17. The method of claim 15, wherein the digital description is generated via a 3D laser scanner.

18. The method of claim 15, wherein the digital description includes information regarding at least one of a building structure and a geometry associated with the building housing the process line.

19. The method of claim 15, wherein the digital description includes information regarding at least one component associated with the process line.

20. A system comprising:
a process line;
an integration platform, comprising:
a first input component for receiving a digital description of physical characteristics associated with a process line;
a second input component for receiving process information via a sensor associated with a component of the process line;
a third input component for receiving virtual reality planning data; and
a processing component for integrating a plurality of the input components to model the structure and function of the process line;
an output component for displaying the model.
